(19) United States
(12) Patent Application Publication
(10) Pub. No.: US 2023/0153781 A1
(43) Pub. Date: May 18, 2023

(54) TRANSACTION DATA PROCESSING METHOD AND APPARATUS

(71) Applicant: CHINA UNIONPAY CO., LTD., Shanghai (CN)

(72) Inventors: Zhirong SHEN, Shanghai (CN); Yanming YANG, Shanghai (CN); Jianbin GAO, Shanghai (CN); Rui LI, Shanghai (CN); Shuzhen WANG, Shanghai (CN); Fuyang WEN, Shanghai (CN); Jinfeng JIANG, Shanghai (CN)

(21) Appl. No.: 17/919,506

(22) PCT Filed: May 10, 2021
(86) PCT No.: PCT/CN2021/092711

§ 371 Date: Oct. 17, 2022

(30) Foreign Application Priority Data
Aug. 28, 2020 (CN) 202010884882.8

(51) Int. Cl. G06Q 20/20; G06Q 20/10

(52) U.S. Cl. CPC G06Q 20/201; G06Q 20/102

(57) ABSTRACT

A transaction data processing method includes: determining one or more transaction key values and one or more transaction feature values of a to-be-processed transaction according to transaction information of the to-be-processed transaction; determining a rule union corresponding to the to-be-processed transaction according to the one or more transaction key values, the rule union including a plurality of to-be-matched rules; matching the one or more transaction feature values of the to-be-processed transaction sequentially with the plurality of to-be-matched rules in the rule union to obtain a rule matching result of the to-be-processed transaction; and performing a billing process of the to-be-processed transaction according to the rule matching result.

### CROSS-REFERENCE TO RELATED APPLICATION

This application claims priority to Chinese Patent Application No. 202010884882.8, entitled “A transaction data processing method and apparatus,” filed on Aug. 28, 2020 with China National Intellectual Property Administration, the entire content of which is incorporated herein by reference.

### TECHNICAL FIELD

The present disclosure relates to the technical field of data processing technologies and, more particularly, to a transaction data processing method and apparatus.

### BACKGROUND

Pricing elements used in transaction pricing come from a transaction message and its associated information. When configuring pricing parameters, each pricing element becomes a column of a parameter table. Different values of the pricing elements are combined according to pricing rules, and each combination is used as a row of the parameter table to form several pricing parameters and each pricing parameter is assigned to corresponding pricing. When calculating a certain fee for a transaction, it is necessary to compare transaction information with sorted pricing parameters one by one. If values of the pricing elements completely match, the fee for the transaction can be determined.

In the existing technology, the pricing elements are directly derived from the transaction messages. Due to large amount of parameters, the maintenance cost is large, the parameter configuration workload is large, and the calculation time is long.

### SUMMARY

The present disclosure provides a transaction data processing method and apparatus, which are used to reduce a number of parameters and improve a transaction billing processing efficiency.

One aspect of the present disclosure provides a transaction data processing method. The method includes: determining one or more transaction key values and one or more transaction feature values of a to-be-processed transaction according to transaction information of the to-be-processed transaction; determining a rule union corresponding to the to-be-processed transaction according to the one or more transaction key values, the rule union including a plurality of to-be-matched rules; matching the one or more transaction feature values of the to-be-processed transaction sequentially with the plurality of to-be-matched rules in the rule union to obtain a rule matching result of the to-be-processed transaction; and performing a billing process of the to-be-processed transaction according to the rule matching result.

In some embodiments, determining the rule union corresponding to the to-be-processed transaction according to the one or more transaction key values includes determining one or more rule enforcers corresponding to the to-be-processed transaction according to the one or more transaction key values, wherein each rule enforcer corresponds to one to-be-matched rule, and the one or more rule enforcers are configured to enforce the plurality of to-be-matched rules. Matching the one or more transaction feature values of the to-be-processed transaction sequentially with the plurality of to-be-matched rules in the rule union to obtain the rule matching result of the to-be-processed transaction includes: according to priorities of the one or more rule enforcers, inputting the one or more transaction feature values sequentially into the one or more rule enforcers to perform a matching process; determining the one or more rule enforcers that match the one or more transaction feature values; and determining a processing standard corresponding to the one or more rule enforcers that match the one or more transaction feature values as the rule matching result.

In some embodiments, each rule enforcer includes a rule trigger and at least one expression enforcer. Inputting the one or more transaction feature values sequentially into the one or more rule enforcers to perform the matching process includes: for any one rule enforcer, inputting the one or more transaction feature values into the at least one expression enforcer according to a preset logical relationship, wherein one expression enforcer corresponds to one feature expression; for any one expression enforcer, comparing the one or more transaction feature values with a target value corresponding to each expression enforcer to obtain a comparison result of the expression enforcer; and determining a matching result of the rule enforcer according to the comparison results of all expression enforcers.

In some embodiments, before determining the one or more transaction key values and the one or more transaction feature values of the to-be-processed transaction according to the transaction information of the to-be-processed transaction, the method further includes: obtaining a to-be-parsed rule union, the to-be-parsed rule union including a plurality of to-be-parsed rules; for any one to-be-parsed rule, determining the rule enforcer corresponding to the to-be-parsed rule according to a logical relationship and a feature expression in the to-be-parsed rule; and according to the rule enforcers corresponding to the plurality of to-be-parsed rules, generating a pool of the rule enforcers corresponding to the to-be-parsed rule union.

In some embodiments, before obtaining the to-be-parsed rule union, the method further includes: determining one or more feature variables based on the message information; using the one or more feature variables to generate one or more feature expressions; connecting the one or more feature expressions through logical symbols to generate the plurality of to-be-parsed rules; and combining the plurality of to-be-parsed rules of a same service type into the to-be-parsed rule union.

Another aspect of the present disclosure provides a transaction data processing apparatus. The apparatus includes: an obtaining unit configured to determine one or more transaction key values and one or more transaction feature values of a to-be-processed transaction according to transaction information of the to-be-processed transaction; a determining unit configured to determine a rule union corresponding to the to-be-processed transaction according to the one or more transaction key values, the rule union including a plurality of to-be-matched rules; a matching unit configured to sequentially match the one or more transaction feature values of the to-be-processed transaction with the plurality of to-be-matched rules in the rule union to obtain a rule matching result of the to-be-processed transaction; and a billing unit configured to perform a billing process of the to-be-processed transaction according to the rule matching result.

In some embodiments, the determining unit is further configured to determine one or more rule enforcers corresponding to the to-be-processed transaction according to the one or more transaction key values, wherein one rule enforcer corresponds to one to-be-matched rule, and the rule enforcer is used to enforce the to-be-matched rule. The matching unit is further configured to: sequentially input the one or more transaction feature values into the one or more rule enforcers to perform a matching process according to priorities of the one or more rule enforcers; determine the one or more rule enforcers that match the one or more transaction feature values; and determine a processing standard corresponding to the one or more rule enforcers matching the one or more transaction feature values as the rule matching result.

In some embodiments, each rule enforcer includes a rule trigger and at least one expression enforcer. The matching unit is further configured to: for any one rule enforcer, input the one or more transaction feature values into the at least one expression enforcer according to a preset logical relationship, wherein one expression enforcer corresponds to one feature expression; for any one expression enforcer, compare the one or more transaction feature values with a target value corresponding to each expression enforcer to obtain a comparison result of the expression enforcer; and determine a matching result of the rule enforcer according to the comparison results of all expression enforcers.

In some embodiments, the apparatus further includes a configuration unit. The configuration unit is configured to: obtain a to-be-parsed rule union, the to-be-parsed rule union including a plurality of to-be-parsed rules; for any one to-be-parsed rule, determine the rule enforcer corresponding to the to-be-parsed rule according to logic symbols and at least one feature expression in the to-be-parsed rule; and according to the rule enforcers corresponding to the plurality of to-be-parsed rules, generate a pool of the rule enforcers corresponding to the to-be-parsed rule union.

In some embodiments, the configuration unit is further configured to: determine one or more feature variables according to the message information; use the one or more feature variables to generate one or more feature expressions; connect the one or more feature expressions through logical symbols to generate the plurality of to-be-parsed rules; and combine the plurality of to-be-parsed rules of a same business type to form the to-be-parsed rule union.

Another aspect of the present disclosure provides a computing device. The computing device includes at least one processor and at least one memory. The at least one memory stores computer programs, and when being executed by the at least one processor, the computer programs cause the at least one processor to perform the disclosed transaction data processing method.

Another aspect of the present disclosure provides a computer-readable storage medium. The computer-readable storage medium includes computer-readable instructions. When being retrieved and executed by a computer, the computer-readable instructions cause the computer to perform the disclosed transaction data processing method.

In the embodiments of the present disclosure, when performing the billing process of the to-be-processed transaction, the one or more transaction key values and the one or more transaction feature values are determined based on the transaction information of the to-be-processed transaction. Based on the one or more transaction key values, the rule union corresponding to the to-be-processed transaction is determined. The rule union includes the plurality of to-be-matched rules. The one or more transaction feature values of the to-processed transaction are matched with the plurality of to-be-matched rules sequentially to obtain the rule matching result of the to-be-processed transaction. Based on the rule matching result, the billing process is performed on the to-be-processed transaction. In some embodiments, pricing parameters are easy-to-understand feature rules. The pricing parameters are easy to read. A number of pricing parameters are substantially reduced. Thus, a probability of parameter mismatch or erroneously matched can be reduced, the number of pricing parameters can be reduced, and an efficiency of transaction billing process can be improved.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic diagram of a system architecture of an exemplary transaction data processing system according to some embodiments of the present disclosure;

FIG. 2 is a flowchart of an exemplary transaction data processing method according to some embodiments of the present disclosure;

FIG. 3 is a schematic structural diagram of an exemplary transaction feature pricing model according to some embodiments of the present disclosure;

FIG. 4 is a schematic structural diagram of an exemplary rule parsing module according to some embodiments of the present disclosure;

FIG. 5 is a flowchart of an exemplary rule parsing process according to some embodiments of the present disclosure;

FIG. 6 is a schematic structural diagram of an exemplary rule enforcer according to some embodiments of the present disclosure;

FIG. 7 is a schematic structural diagram of an exemplary rule matching module according to some embodiments of the present disclosure;

FIG. 8 is a block diagram of an exemplary transaction data processing apparatus according to some embodiments of the present disclosure; and

FIG. 9 is a block diagram of an exemplary server according to some embodiments of the present disclosure.

### DETAILED DESCRIPTION OF THE EMBODIMENTS

In order to make the objectives, technical solutions, and advantages of the present disclosure clearer, the present disclosure will be further described in detail below with reference to the accompanying drawings. Obviously, the described embodiments are only a part of the embodiments of the present disclosure, not all of the embodiments. Based on the embodiments of the present disclosure, all other embodiments obtained by those of ordinary skill in the art without creative efforts shall fall within the protection scope of the present disclosure.

Terms such as “first” and “second” in the description and claims of the present disclosure and the drawings are used to distinguish different objects, rather than to describe a specific order. Further, the term “comprising” and any variations thereof are intended to cover non-exclusive protections. For example, a process, a method, a system, a product or a device comprising a series of steps or units is not limited to listed steps or units, but optionally also includes unlisted steps or units, or optionally also includes other steps or units inherent to the process, the method, the product or device.

The following briefly introduces the architecture of the technical solutions of the embodiments of the present disclosure. It should be noted that the architectures introduced below are only used to illustrate the embodiments of the present disclosure and are not intended to be limiting. During specific implementation, the technical solutions provided by the embodiments of the present disclosure may be flexibly applied according to actual needs.

In order to further illustrate the technical solutions provided by the embodiments of the present disclosure, the following detailed descriptions are given in conjunction with the accompanying drawings and specific embodiments. Although the embodiments of the present disclosure provide method operation steps as shown in the following embodiments or the accompanying drawings, more or less operation steps may be included in the method based on routine or without creative work. In steps that logically do not have a necessary causal relationship, the execution order of these steps is not limited to the execution order provided by the embodiments of the present disclosure.

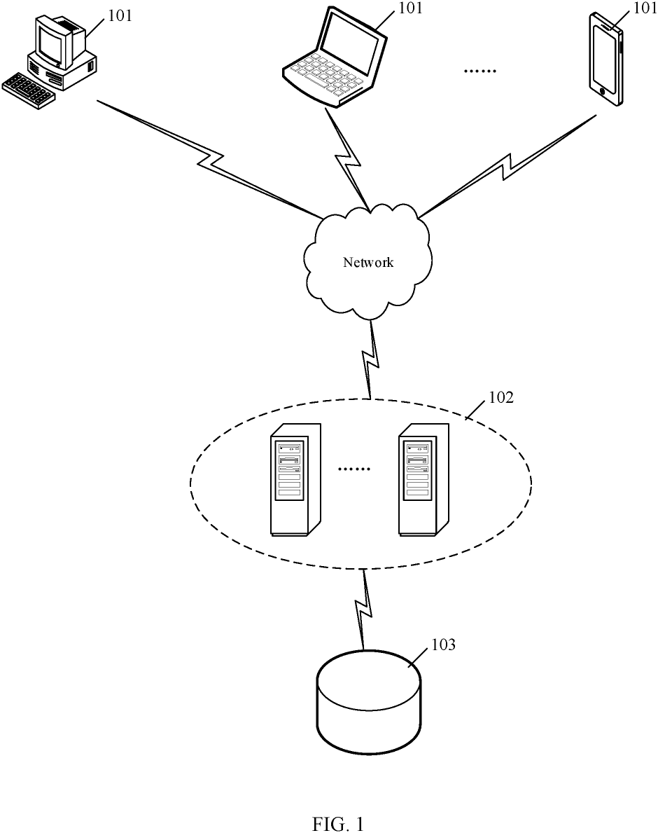

FIG. 1 is a schematic diagram of a system architecture of an exemplary transaction data processing system according to some embodiments of the present disclosure. As shown in FIG. 1, the transaction data processing system in this application scenario includes a terminal device 101, a server 102, and a database 103. The terminal device 101 is installed with a client application. The server 102 is a server corresponding to the client application. The terminal device 101 may be a mobile phone, a personal computer (PC), a tablet computer or PAD, a personal digital assistant (PDA), a laptop computer, or a wearable device (e.g., a smart watch or smart bracelet). The terminal device 101 is connected to the server 102 through a communication network. The communication network may be a wireless network or wired network. The server 102 may be a server corresponding to the client, may be a server cluster or a cloud computing center including one or more servers, or may be a virtual platform.

As shown in FIG. 1, the database 103 is separated from the server 102. In some other embodiments, the database 103 may be located inside the server 102.

The server 102 is connected to the database 103. After the server 102 generates a to-be-parsed rule union based on transaction messages, the to-be-parsed rule union may be stored in the database 103. The server 102 obtains the to-be-parsed rule union from the database 103, parses the to-be-parsed rule union to generate one or more rule enforcers, and further generates a pool of the rule enforcers. As such, when the transaction is processed for fees or billing, the server 102 may input the transaction features into the one or more rule enforcer to perform a rule matching, and process for fees according to a rule matching result.

Of course, system architectures provided by the embodiments of the present disclosure are not limited to the system architecture shown in FIG. 1. The present disclosure does not limit. To further describe the technical solutions provided by the embodiments of the present disclosure, descriptions are provided below in detail with reference to the accompanying drawings and specific embodiments. Although the embodiments of the present disclosure provide the operation steps of the method shown in the embodiments or the accompanying drawings, more or less operation steps may be included in the method based on routine or without creative work. For steps that do not have cause and effect relationships logically, an execution order of these steps is not limited to the execution order provided by the embodiments of the present disclosure.

The pricing elements (pricing dimensions) of transaction classification include: business type, pricing alliance, transaction mode, product type, transaction type, transaction channel, transaction medium, transaction amount (with currency type), institution role, acceptance area, acceptance institution, sending institution, card issuing area, receiving institution, card issuing institution, merchant code, merchant type, merchant type classification, service point input method, code scanning method, card BIN, card nature, card level, card product, installment payment period, and authentication information, etc.

Transaction pricing generally selects a number of pricing elements, and assigns different fee prices according to different value combinations of the pricing elements. Because fees are different for different transactions, the pricing elements used in pricing will also be different. In the embodiments of the present disclosure, when a transaction is classified, values of all the pricing elements of the transaction are obtained based on transaction information processing, and are compared with value combinations of billing elements set in a fee pricing setting one by one, until a complete match is found with a value combination to obtain the corresponding fee price.

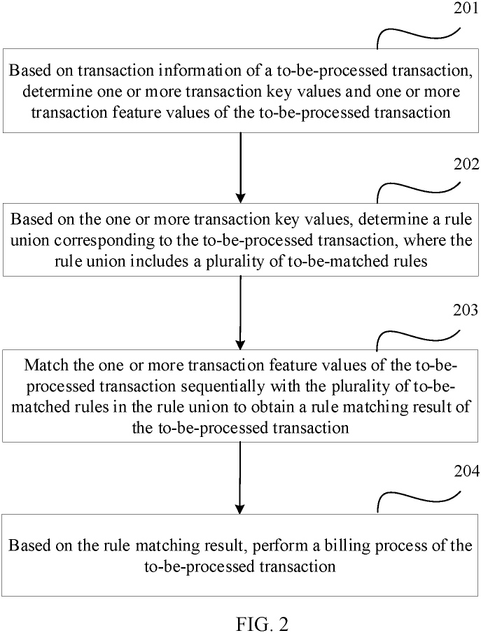

FIG. 2 is a flowchart of an exemplary transaction data processing method according to some embodiments of the present disclosure. The method may be applied to the scenario show in FIG. 1. As shown in FIG. 2, the method includes the following processes.

At step 201, based on transaction information of a to-be-processed transaction, determine one or more transaction key values and one or more transaction feature values of the to-be-processed transaction.

At step 202, based on the one or more transaction key values, determine a rule union corresponding to the to-be-processed transaction, where the rule union includes a plurality of to-be-matched rules.

At step 203, match the one or more transaction feature values of the to-be-processed transaction sequentially with the plurality of to-be-matched rules in the rule union to obtain a rule matching result of the to-be-processed transaction.

At step 204, based on the rule matching result, perform a billing process of the to-be-processed transaction.

In the embodiments of the present disclosure, when performing the billing process of the to-be-processed transaction, the one or more transaction key values and the one or more transaction feature values are determined based on the transaction information of the to-be-processed transaction. Based on the one or more transaction key values, the rule union corresponding to the to-be-processed transaction is determined. The rule union includes the plurality of to-be-matched rules. The one or more transaction feature values of the to-processed transaction are matched with the plurality of to-be-matched rules sequentially to obtain the rule matching result of the to-be-processed transaction. Based on the rule matching result, the billing process is performed on the to-be-processed transaction. In some embodiments, pricing parameters are easy-to-understand feature rules. The pricing parameters are easy to read. A number of pricing parameters are substantially reduced. Thus, a probability of parameter mismatch or erroneously matched can be reduced, the number of pricing parameters can be reduced, and an efficiency of transaction billing process can be improved.

In some embodiments, because the one or more rule enforcers can be easily expanded, to facilitate expansion and execution of rules, the plurality of to-be-matched rules stored inside the rule enforcer are used to match the one or more transaction feature values. Configuration process of the one or more rule enforcers is described below.

One rule enforcer corresponds to one feature rule. Before the rule enforcer is configured, the feature rule needs to be determined. Thus, before a to-be-parsed rule union is obtained, the method further includes: determining one or more feature variables based on the message information; using the one or more feature variables to generate one or more feature expressions; connecting the one or more feature expressions through logical symbols to generate the plurality of to-be-parsed rules; and combining the plurality of to-be-parsed rules of a same service type into the to-be-parsed rule union.

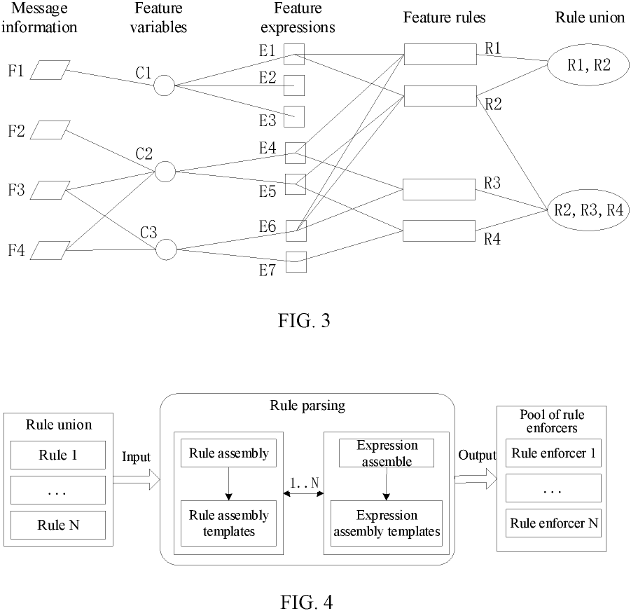

In some embodiments, a transaction feature pricing model is defined. The model includes the message information, the one or more feature variables, the one or more feature expressions, the one or more feature rules, and the one or more rule unions. FIG. 3 is a schematic structural diagram of an exemplary transaction feature pricing model according to some embodiments of the present disclosure. As shown in FIG. 3, elements in each layer can be freely expanded. Element mapping relationship is configured between two adjacent layers. The elements can be reused in multiple mapping relationships.

The message information comes from the transaction message. For example, the to-be-processed transaction is a bank card transaction. The transaction message has an ISO8583 format. The transaction message includes a plurality of message fields. There are 128 message fields. A common message field includes F2 master account number, F3 transaction processing code, F4 transaction amount, F18 merchant type, F22 service point input method code, and F49 transaction currency code, etc.

The one or more feature variables refer to the pricing elements used in business pricing. The mapping relationships between the one or more feature variables and the message information are configured. Contents of each mapping relationship include: a feature variable name, transaction information field names, a mapping type, and a mapping script, etc. A value of the one or more feature variables can be calculated by a program based on the transaction information and the mapping relationship. The mapping type includes, but is not limited to: (1) exactly the same, for example: “merchant type”, which is directly obtained from F18 merchant type of the transaction information; (2) field interception, for example: “accepting country and region”, which is the last four digits of F32 acceptance institution code (8-digit string) intercepted from the transaction information; (3) field splicing, for example: “transaction amount (with currency type)”, which includes F49 transaction currency code and F4 transaction amount spliced together; (4) references and supplements, for example: “card BIN”, “card nature”, “card brand”, and “card level”, etc., which are obtained through searching the parameters with F2 master account number of the transaction information; (5) customization, which can be obtained by using certain program logic to process the transaction information and other feature variables. For example, the value of “pricing alliance” can be calculated through the mapping script based on F33 sending institution, F100 receiving institution, “card BIN”, “accepting country and region”, and “card issuing countries and regions”.

The feature expression is defined as a triplet <feature variable, operator, operand>. The operator can be “=”, “<>”, “>”, “<”, and “IN”, etc. The operand can be an integer, a floating-point number, a string, and a billing amount with the currency type, etc. The result of the expression is a Boolean True (yes) or False (no). Assuming that there are feature variables: C1 transaction channel, C2 business type, the feature expression can be, for example, as follows:
Expression E001: C1=0′3′, meaning: the transaction channel is equal to 03;
Expression E002: C1<>′01′ meaning: the transaction channel is not equal to 01; and
Expression E003: C2 IN (‘B01’, ‘B02’), meaning: the business type is B01 or B02.

The one or more feature variables may be defined through multiple feature expressions.

The feature rules include multiple feature expressions connected by logical relationships. Symbols of the logical relationship include “&” and, “|” or, “!” not, and “()” brackets, etc. A result of the feature rules is also Boolean.

Examples of the feature rules are as follows:
Feature rule R001: (E001 & E003), that is, E001 and E003 have an “and” relationship. If both expressions are True, then the rule result is True.
Feature rule R002: ((E002 | E003) & E004), that is, E001 and E003 have an “or” relationship, and the result thereof and E004 are then “anded”.

It should be noted that the feature expression can be reused by multiple feature rules.

The rule union is a collection of multiple feature rules formed according to a certain priority or order. One feature rule can be referenced by multiple rule unions, and the same feature rule can have different priorities in different rule unions.

Examples of a rule package are as follows:
Rule package P001: {{1 R001 }, {2 R003}, {3 R002} }, meaning: there are three rules in the rule package, corresponding to priorities 1, 2, and 3, respectively.
Rule package P002: {{1 R003},{2 R001}}, meaning: there are two rules in the rule package, corresponding to priorities 1 and 2, respectively.

The final result of the above transaction feature pricing model includes multiple rule unions. Each rule union corresponds to a business type. The number of the one or more feature variables, that is, the pricing elements, can be expanded arbitrarily, and the values of the one or more feature variables can be expanded by increasing the types of operators and operands. The feature rule may contain any number of the feature expressions, and the rule union may refer to any number of the feature rules. Thus, the transaction feature pricing model in the embodiments of the present disclosure is substantially scalable, and the elements and the mapping relationships therein can be freely changed.

The configuration process of the above rule union is described below with a consumption transaction. The pricing rules in the transaction message are as follows: the exchange fee for diamond card consumption is 1.2%, the exchange fee for platinum card consumption is 1.1%, and the exchange fee for other consumption transactions is 1.0%. The steps to configure the rule union are as follows.

(1) The feature variables card level (C1) and transaction type (C2) are extracted from the pricing rules of the transaction message.

(2) The mapping relationship between C1 and C2, and the message field is configured in the mapping table between the feature variables and the transaction information.

(3) The feature expression is constructed according to the above feature variables, where the expression of the card level includes: E001: C1=′diamond′, E002: C1=′platinum′, and the expression of the transaction type includes: E003: C2=′consumption ′.

(4) The feature rules R001, R002, and R003 are constructed respectively as: R001: (E001 & E003), diamond card consumption; R002: (E002 & E003), platinum card consumption; and R003: ((!E001 & !E002) & E003), other card consumption.

(5) The rule union P001: { {1 R001}, {2 R002}, {3 R003}} is constructed. Specifically, three feature rules R001, R002, and R003 are assigned priorities, and the feature rules and pricing standards are associated in the rule union. For example, the corresponding exchange fee standard for R001 is 1.2%, and the corresponding exchange fee standard for R003 is 1.0%.

In terms of businesses, the rule union may correspond to the fee pricing of the same type of business. In order to facilitate identification, one or more business primary key values <business type, expense type> are configured for the rule union, that is, the corresponding rule union can be found according to the one or more business primary key values. In the rule union, multiple pricing rules and fees thereof can be defined for various scenarios. Further, the rule union is saved in the database in a Json format.

Further, the server obtains the aggregated to-be-parsed rule unions from the database, and generates a corresponding pool of rules. Specifically, before determining the one or more transaction key values and the one or more transaction feature values of the to-be-processed transaction according to the transaction information of the to-be-processed transaction, the method further includes: obtaining the to-be-parsed rule unions, where the to-be-parsed rule unions include a plurality of to-be-parsed rules; for any one to-be-parsed rule, determining a rule enforcer corresponding to the to-be-parsed rule according to the logical relationship and the feature expression in the to-be-parsed rule; according to the rule enforcers corresponding to the plurality of to-be-parsed rules, generating a pool of the rule enforcers corresponding to the to-be-parsed rule unions.

In some embodiments, the server obtains the to-be-parsed rule union from the database, installs the configured to-be-parsed rule union into an application program for rule parsing, and assembles a callable rule enforcer according to the to-be-parsed rules in the to-be-parsed rule union. One rule enforcer corresponds to each to-be-parsed rule. For the to-be-parsed rule union, multiple to-be-parsed rules contained in the rule union correspond to multiple rule enforcers, respectively. The multiple rule enforcers corresponding to the same to-be-parsed rule union are combined into a pool of the rule enforcers. The pool of the rule enforcers corresponds to the one or more business primary key values. Thus, the one or more business primary key values can be determined according to the transaction information, and then the matching pool of the rule enforcers can be determined according to the corresponding relationship between the pool of the rule enforcers and the one or more business primary key values.

Specifically, the rule union includes N feature rules, which are rule 1, rule 2, ... rule N, respectively. The N feature rules are inputted into a rule parsing module. FIG. 4 is a schematic structural diagram of an exemplary rule parsing module according to some embodiments of the present disclosure. As shown in FIG. 4, the rule parsing module includes a rule assembly module and expression assembly templates. The rule assembly module is configured to use assembly templates of logic operands to connect the multiple feature expressions in the feature rules. The assembly templates of the logic operands include an “and” template, an “or” template, and a “not” template, etc. The expression assembly templates are configured to use assemble templates of arithmetic operands to assemble the multiple feature expressions. The assemble templates of the arithmetic operands include an “equal to” template, a “not equal to” template, and a “belongs to” template, etc.

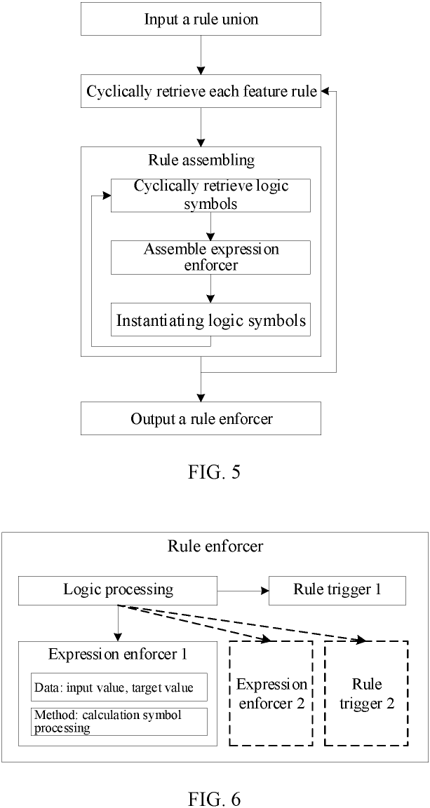

The rule parsing module parses and assembles each feature rule to obtain the corresponding rule enforcer. FIG. 5 is a flowchart of an exemplary rule parsing process according to some embodiments of the present disclosure. In some embodiments, as shown in FIG. 5, the rule parsing process includes obtaining the one or more rule enforcers by parsing the feature rules, and then forming the rule union. The rule union that includes multiple feature rules is inputted into the rule assembly module. Each feature rule is retrieved cyclically, and the rule enforcer is assembled according to the feature rule. The rule parsing process further includes reading the logical symbols connecting the feature expressions in the feature rule, reading the feature expressions contained in the feature rule, assembling an expression enforcer according to the feature expressions, and instantiating the logic symbols to generate the rule enforcer. Further, N rule enforcers are generated according to the N feature rules. For example, a rule 1 is parsed to assemble a rule enforcer 1, a rule 2 is parsed to assemble a rule enforcer 2, ..., and a rule N is parsed to assemble a rule enforcer N.

Therefore, the rule parsing module outputs the rule enforcer 1, the rule enforcer 2, ..., and the rule enforcer N. The above N rule enforcers form a pool of the rule enforcers, and one rule union corresponds to one pool of the rule enforcers.

FIG. 6 is a schematic structural diagram of an exemplary rule enforcer according to some embodiments of the present disclosure. The rule enforcer is formed according to the to-be-parsed rule. The rule enforcer includes a logic processing module, one or more expression enforcers, and one or more rule triggers. The rule enforcer contains at least one expression enforcer and at least one rule trigger. The at least one expression enforcer corresponds to the at least one rule trigger. Further, the rule enforcer may also include multiple expression enforcers and corresponding rule triggers, where any one expression enforcer corresponds to one rule trigger. For example, as shown in FIG. 6, expression enforcer 1 corresponds to rule trigger 1, and expression enforcer 2 corresponds to rule trigger 2.

The rule enforcer can also recursively nest other rule enforcers. The expression enforcer includes a data part and a method part.

Further, inputting the one or more transaction feature values sequentially into the multiple rule enforcers to perform the matching process includes: for any one rule enforcer, inputting by the rule enforcer the one or more transaction feature values into the expression enforcer according to a preset logical relationship, where one expression enforcer corresponds to one feature expression; for any one expression enforcer, comparing by the expression enforcer the one or more transaction feature values with a target value corresponding to the expression enforcer to obtain a comparison result of the expression enforcer; and determining by the rule trigger a matching result of the rule enforcer according to the comparison results of all expression enforcers.

In some embodiments, the logic processing module in the rule enforcer is used to perform a logical operation process on the results of multiple expression enforcers, and to return True (Yes) or False (No). The result returned by an outermost logic processing module is used to determine whether the rule matches. The rule trigger is used to execute an action after the rule is matched, and a content of the action can be customized according to an actual application.

For illustration purpose, the above-described consumer transaction is used as an example. After the rule union P001 is parsed, a corresponding pool of the enforcers is generated. The pool of the enforcers contains three rule enforcers corresponding to R001, R002, and R003. For example, in the expression R003:((!E001 & !E002) &E003), the logical processing of the outermost rule enforcer is “AND” operation, which contains an expression enforcer “E003” and a nested rule enforcer “!E001 & !E002”. The data value inputted into the expression enforcer “E003” is the feature variable C2, the target value is “consumption”, and a calculation method is “equal to”. If the matching result obtained by the enforcer corresponding to rule R003 is True, then the corresponding rule trigger will be triggered.

In the above-described process, multiple pools of the rules are formed, and each pool of the rules corresponds to one business primary key value. Thus, when the transaction data of a business type needs to be processed and cleared, the one or more transaction key values, that is, the one or more business primary key values, can be determined according to the transaction data, and then the corresponding pool of the rules can be found. Further, the pool of the rules is used to match the one or more transaction feature values.

Determining the rule union corresponding to the to-be-processed transaction according to the one or more transaction key values includes: determining the one or more rule enforcers corresponding to the to-be-processed transaction according to the one or more transaction key values, where one rule enforcer corresponds to one to-be-matched rule, and the one or more rule enforcers are used to enforce the to-be-matched rule.

Matching the one or more transaction feature values of the to-be-processed transaction sequentially with multiple to-be-matched rules in the rule union to obtain the rule matching result of the to-be-processed transaction includes: sequentially inputting the one or more transaction feature values into the multiple rule enforcers to perform the matching process according to the priorities of the one or more rule enforcers; determining the one or more rule enforcers that match the one or more transaction feature values; and determining a processing standard corresponding to the one or more rule enforcers matching the one or more transaction feature values as the rule matching result.

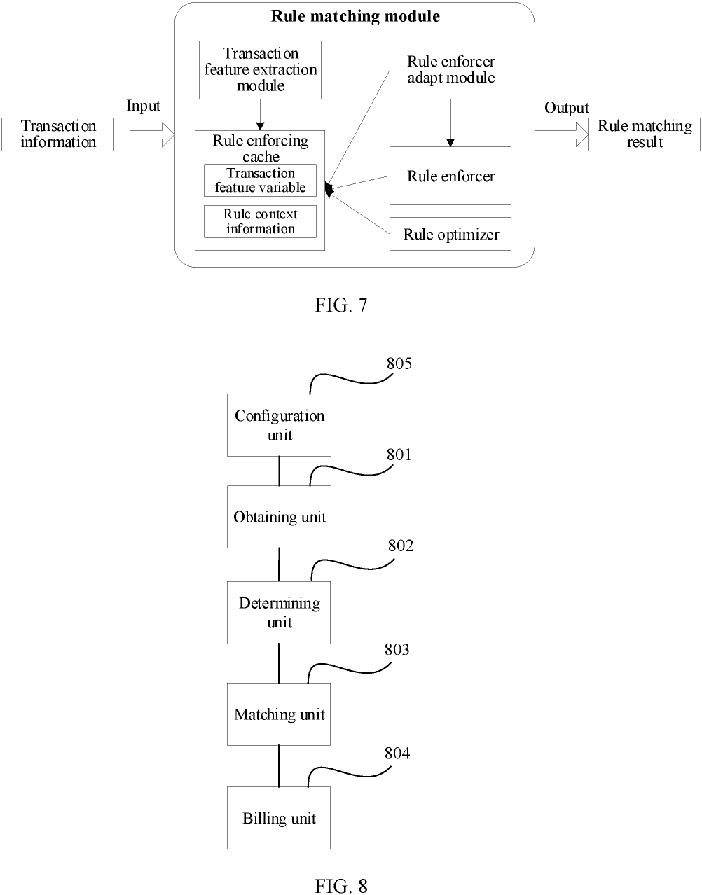

FIG. 7 is a schematic structural diagram of an exemplary rule matching module according to some embodiments of the present disclosure. In some embodiments, as shown in FIG. 7, a transaction feature extraction module extracts and calculates the feature variable value used in the pricing rule from the transaction information, and then adapts and launches the rule enforcer. When clearing transactions in batches, the rule enforcer is shared, but each thread of processing the transaction has an independent rule enforcing cache. The calculation result of the feature expression is cached in rule context information. The same feature expression used by multiple rules does not need to be recalculated. After the rule enforcer is applied, the rule trigger returns the result and performs other configured actions.

A rule optimizer collects the matching information of each feature expression during the rule enforcing process (the number of times of invoking the rule, the number of times of enforcing the rule, and the number of times of mismatching). After the transactions are cleared in batches each day, the matching information will be aggregated for statistical analysis. A discrimination value of the feature expression is calculated to optimize the feature rule parameters, thereby improving the matching efficiency of the rule enforcer.

The above process will be described in detail below in various embodiments.

For example, the transaction is the above-described consumption transaction. The one or more transaction key values and the one or more transaction feature values are determined according to the transaction information, and the one or more business primary key values <consumption, exchange fee> according to the business logic.

According to the one or more business primary key values, the pool of the rules P001 is obtained, and the pool of the rules includes rule enforcers (R001, R002, R003). The rule enforcers are launched sequentially according to the priorities recorded therein, and the result of the rule matching is obtained. The transaction is then billed according to the rule matching result.

The following is an apparatus consistent with the embodiments of the present disclosure. For details that are not described in detail in the apparatus embodiments, reference may be made to the above-described method embodiments one-to-one correspondingly.

FIG. 8 is a block diagram of an exemplary transaction data processing apparatus according to some embodiments of the present disclosure. As shown in FIG. 8, the transaction data processing apparatus is implemented by hardware or a combination of software and hardware to become all or a part of the server 102 shown in FIG. 1. The apparatus includes: an obtaining unit 801 configured to determine the one or more transaction key values and the one or more transaction feature values of the to-be-processed transaction according to the transaction information of the to-be-processed transaction; a determining unit 802 configured to determine a rule union corresponding to the to-be-processed transaction according to the one or more transaction key values, where the rule union includes a plurality of to-be-matched rules; a matching unit 803 configured to sequentially match the one or more transaction feature values of the to-be-processed transaction with the plurality of to-be-matched rules in the rule union to obtain the rule matching result of the to-be-processed transaction; and a billing unit 804 configured to perform the billing process of the to-be-processed transaction according to the rule matching result.

Further, the determining unit 802 is further configured to: determine the one or more rule enforcers corresponding to the to-be-processed transaction according to the one or more transaction key values, where one rule enforcer corresponds to one to-be-matched rule, and the rule enforcer is used to enforce the to-be-matched rule. The matching unit 803 is further configured to sequentially input the one or more transaction feature values into the multiple rule enforcers to perform the matching process according to the priorities of the multiple rule enforcers; determine the one or more rule enforcers that match the one or more transaction feature values; and determine the processing standard corresponding to the one or more rule enforcers matching the one or more transaction feature values as the rule matching result.

Further, each rule enforcer includes a rule trigger and at least one expression enforcer. The matching unit 803 is further configured to: for any one rule enforcer, input the one or more transaction feature values into the expression enforcer according to the preset logical relationship, where one expression enforcer corresponds to one feature expression; for any one expression enforcer, compare the one or more transaction feature values with the target value corresponding to the expression enforcer to obtain the comparison result of the expression enforcer; determine the matching result of the rule enforcer according to the comparison results of all expression enforcers.

Further, the apparatus includes a configuration unit 805 configured to: obtain a to-be-parsed rule union, where the to-be-parsed rule union includes the plurality of to-be-parsed rules; for any one to-be-parsed rule, determine the rule enforcer corresponding to the to-be-parsed rule according to the logic symbols and the feature expressions in the to-be-parsed rule; and according to the one or more rule enforcers corresponding to the plurality of to-be-parsed rules, generate the pool of the rule enforcers corresponding to the to-be-parsed rule union.

Further, the configuration unit 805 is configured to: determine the one or more feature variables according to the message information; use the one or more feature variables to generate the one or more feature expressions; connect the one or more feature expressions through the logical symbols to generate the plurality of to-be-parsed rules; and combine the plurality of to-be-parsed rules of the same business type to form the to-be-parsed rule union.

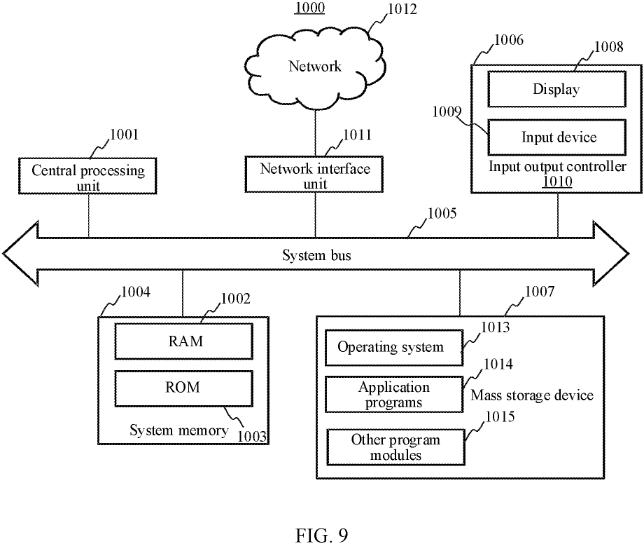

FIG. 9 is a block diagram of an exemplary server according to some embodiments of the present disclosure. The server 1000 is implemented as the server 102 shown in FIG. 1. As shown in FIG. 9, the server 1000 includes a central processing unit (CPU) 1001, a system memory 1004 including a random access memory (RAM) 1002 and a read only memory (ROM) 1003, and a system bus 1005 connecting the system memory 1004 and the central processing unit 1001. The server 1000 also includes a basic input/output system (I/O system) 1006 that facilitates the transfer of information between various devices within the computer, and a mass storage device 1007 for storing an operating system 1013, application programs 1014, and other program modules 1015.

The basic input/output system 1006 includes a display 1008 for displaying information and an input device 1009 such as a mouse, a keyboard, etc., for a user to input information. The display 1008 and the input device 1009 are both connected to the central processing unit 1001 through an input and output controller 1010 connected to the system bus 1005. The basic input/output system 1006 may also include the input output controller 1010 for receiving and processing inputs from a number of other devices such as the keyboard, the mouse, or an electronic stylus. Similarly, the input output controller 1010 also provides outputs to a display screen, a printer, or other type of output devices.

The mass storage device 1007 is connected to the central processing unit 1001 through a mass storage controller (not shown) connected to the system bus 1005. The mass storage device 1007 and its associated computer-readable media provide non-volatile storage for the server 1000. That is, the mass storage device 1007 may include a computer-readable medium (not shown) such as a hard disk or a CD-ROM drive.

The computer-readable medium may include a computer storage medium and a communication medium. The computer storage medium includes volatile and nonvolatile, removable and non-removable media implemented in any method or technology for storage of information such as computer readable instructions, data structures, program modules or other data. The computer storage medium includes RAM, ROM, EPROM, EEPROM, flash memory or other solid state storage technology, CD-ROM, DVD or other optical storage, magnetic cassettes, magnetic tape, magnetic disk storage or other magnetic storage devices. Of course, those skilled in the art understand that the computer storage medium is not limited to the above-described ones. The system memory 1004 and the mass storage device 1007 described above may be collectively referred to as memory.

According to various embodiments of the present disclosure, the server 1000 may also be operated by connecting to a remote computer through a network such as Internet. That is, the server 1000 can be connected to the network 1012 through a network interface unit 1011 connected to the system bus 1005, or in other words, the network interface unit 1011 can also be used to connect to other types of networks or remote computer systems (not shown) .

The memory further includes one or more programs. The one or more programs are stored in the memory, and include instructions for performing the transaction data processing method provided by the embodiment of the present disclosure.

Those of ordinary skill in the art can understand that all or part of the steps in the method in the above embodiments can be completed by instructing relevant hardware through a program. The program can be stored in a computer-readable storage medium. The computer-readable storage medium may include: a read only memory (ROM), a random access memory (RAM), a magnetic disk or a CD, etc.

Those of ordinary skill in the art can understand that all or part of the steps in the method of the above embodiments can be completed by instructing relevant hardware through a program. The program can be stored in the computer-readable storage medium. The computer-readable storage medium may include: the read-only memory (ROM), the random access memory (RAM), the magnetic disk or the optical disk, etc.

The above-mentioned serial numbers of the embodiments of the present disclosure are only for illustration purpose, and do not represent advantages or disadvantages of the embodiments.

Although the embodiments of the present disclosure have been described, additional changes and modifications to these embodiments may occur to those skilled in the art once the basic inventive concepts are known. Therefore, the appended claims are intended to be construed to include the embodiments and all changes and modifications that fall within the scope of the present disclosure.

It will be apparent to those skilled in the art that various modifications and variations can be made in the present disclosure without departing from the spirit and scope of the disclosure. Thus, if these modifications and variations of the present disclosure fall within the scope of the claims of the present application and their equivalents, the present disclosure is also intended to include these modifications and variations.

1. A transaction data processing method, comprising:
determining one or more transaction key values and one or more transaction feature values of a to-be-processed transaction according to transaction information of the to-be-processed transaction;
determining a rule union corresponding to the to-be-processed transaction according to the one or more transaction key values, the rule union including a plurality of to-be-matched rules;
matching the one or more transaction feature values of the to-be-processed transaction sequentially with the plurality of to-be-matched rules in the rule union to obtain a rule matching result of the to-be-processed transaction; and
performing a billing process of the to-be-processed transaction according to the rule matching result.

2. The method according to claim 1, wherein:
determining the rule union corresponding to the to-be-processed transaction according to the one or more transaction key values includes:
determining one or more rule enforcers corresponding to the to-be-processed transaction according to the one or more transaction key values, wherein each rule enforcer corresponds to one to-be-matched rule, and the one or more rule enforcers are configured to enforce the plurality of to-be-matched rules; and
matching the one or more transaction feature values of the to-be-processed transaction sequentially with the plurality of to-be-matched rules in the rule union to obtain the rule matching result of the to-be-processed transaction includes:
according to priorities of the one or more rule enforcers, inputting the one or more transaction feature values sequentially into the one or more rule enforcers to perform a matching process;
determining the one or more rule enforcers that match the one or more transaction feature values; and
determining a processing standard corresponding to the one or more rule enforcers that match the one or more transaction feature values as the rule matching result.

3. The method according to claim 2, wherein:
each rule enforcer includes a rule trigger and at least one expression enforcer; and
inputting the one or more transaction feature values sequentially into the one or more rule enforcers to perform the matching process includes:
for any one rule enforcer, inputting the one or more transaction feature values into the at least one expression enforcer according to a preset logical relationship, wherein one expression enforcer corresponds to one feature expression;
for any one expression enforcer, comparing the one or more transaction feature values with a target value corresponding to each expression enforcer to obtain a comparison result of the expression enforcer; and
determining a matching result of the rule enforcer according to the comparison results of all expression enforcers.

4. The method according to claim 2, wherein before determining the one or more transaction key values and the one or more transaction feature values of the to-be-processed transaction according to the transaction information of the to-be-processed transaction, the method further comprises:
obtaining a to-be-parsed rule union, the to-be-parsed rule union including a plurality of to-be-parsed rules;
for any one to-be-parsed rule, determining the rule enforcer corresponding to the to-be-parsed rule according to a logical relationship and a feature expression in the to-be-parsed rule; and
according to the rule enforcers corresponding to the plurality of to-be-parsed rules, generating a pool of the rule enforcers corresponding to the to-be-parsed rule union.

5. The method according to claim 4, wherein before obtaining the to-be-parsed rule union, the method further comprises:
determining one or more feature variables based on the message information;
using the one or more feature variables to generate one or more feature expressions;
connecting the one or more feature expressions through logical symbols to generate the plurality of to-be-parsed rules; and
combining the plurality of to-be-parsed rules of a same service type into the to-be-parsed rule union.

6. (canceled)

7. (canceled)

8. (canceled)

9. (canceled)

10. (canceled)

11. A computing device, comprising:
at least one processor; and
at least one memory;
wherein the memory stores computer programs, and when being executed by the at least one processor, the computer programs cause the at least one processor to perform :
determining one or more transaction key values and one or more transaction feature values of a to-be-processed transaction according to transaction information of the to-be-processed transaction;
determining a rule union corresponding to the to-be-processed transaction according to the one or more transaction key values, the rule union including a plurality of to-be-matched rules;
matching the one or more transaction feature values of the to-be-processed transaction sequentially with the plurality of to-be-matched rules in the rule union to obtain a rule matching result of the to-be-processed transaction; and
performing a billing process of the to-be-processed transaction according to the rule matching result.

12. A computer-readable storage medium, comprising:
computer-readable instructions, wherein when being retrieved and executed by a computer, the computer-readable instructions cause the computer to perform a transaction data processing method, the method including:
determining one or more transaction key values and one or more transaction feature values of a to-be-processed transaction according to transaction information of the to-be-processed transaction;
determining a rule union corresponding to the to-be-processed transaction according to the one or more transaction key values, the rule union including a plurality of to-be-matched rules;
matching the one or more transaction feature values of the to-be-processed transaction sequentially with the plurality of to-be-matched rules in the rule union to obtain a rule matching result of the to-be-processed transaction; and
performing a billing process of the to-be-processed transaction according to the rule matching result.

13. The computing device according to claim 11, wherein:
determining the rule union corresponding to the to-be-processed transaction according to the one or more transaction key values includes:
determining one or more rule enforcers corresponding to the to-be-processed transaction according to the one or more transaction key values, wherein each rule enforcer corresponds to one to-be-matched rule, and the one or more rule enforcers are configured to enforce the plurality of to-be-matched rules; and
matching the one or more transaction feature values of the to-be-processed transaction sequentially with the plurality of to-be-matched rules in the rule union to obtain the rule matching result of the to-be-processed transaction includes:
according to priorities of the one or more rule enforcers, inputting the one or more transaction feature values sequentially into the one or more rule enforcers to perform a matching process;
determining the one or more rule enforcers that match the one or more transaction feature values; and
determining a processing standard corresponding to the one or more rule enforcers that match the one or more transaction feature values as the rule matching result.

14. The computing device according to claim 13, wherein:
each rule enforcer includes a rule trigger and at least one expression enforcer; and
inputting the one or more transaction feature values sequentially into the one or more rule enforcers to perform the matching process includes:
for any one rule enforcer, inputting the one or more transaction feature values into the at least one expression enforcer according to a preset logical relationship, wherein one expression enforcer corresponds to one feature expression;
for any one expression enforcer, comparing the one or more transaction feature values with a target value corresponding to each expression enforcer to obtain a comparison result of the expression enforcer; and
determining a matching result of the rule enforcer according to the comparison results of all expression enforcers.

15. The computing device according to claim 13, wherein before determining the one or more transaction key values and the one or more transaction feature values of the to-be-processed transaction according to the transaction information of the to-be-processed transaction, the method further comprises:
obtaining a to-be-parsed rule union, the to-be-parsed rule union including a plurality of to-be-parsed rules;
for any one to-be-parsed rule, determining the rule enforcer corresponding to the to-be-parsed rule according to a logical relationship and a feature expression in the to-be-parsed rule; and
according to the rule enforcers corresponding to the plurality of to-be-parsed rules, generating a pool of the rule enforcers corresponding to the to-be-parsed rule union.

16. The computing device according to claim 15, wherein before obtaining the to-be-parsed rule union, the method further comprises:
determining one or more feature variables based on the message information;
using the one or more feature variables to generate one or more feature expressions;
connecting the one or more feature expressions through logical symbols to generate the plurality of to-be-parsed rules; and
combining the plurality of to-be-parsed rules of a same service type into the to-be-parsed rule union.

17. The computer-readable storage medium according to claim 12, wherein:
determining the rule union corresponding to the to-be-processed transaction according to the one or more transaction key values includes:
determining one or more rule enforcers corresponding to the to-be-processed transaction according to the one or more transaction key values, wherein each rule enforcer corresponds to one to-be-matched rule, and the one or more rule enforcers are configured to enforce the plurality of to-be-matched rules; and
matching the one or more transaction feature values of the to-be-processed transaction sequentially with the plurality of to-be-matched rules in the rule union to obtain the rule matching result of the to-be-processed transaction includes:
according to priorities of the one or more rule enforcers, inputting the one or more transaction feature values sequentially into the one or more rule enforcers to perform a matching process;
determining the one or more rule enforcers that match the one or more transaction feature values; and
determining a processing standard corresponding to the one or more rule enforcers that match the one or more transaction feature values as the rule matching result.

18. The computer-readable storage medium according to claim 17, wherein:
each rule enforcer includes a rule trigger and at least one expression enforcer; and
inputting the one or more transaction feature values sequentially into the one or more rule enforcers to perform the matching process includes:
for any one rule enforcer, inputting the one or more transaction feature values into the at least one expression enforcer according to a preset logical relationship, wherein one expression enforcer corresponds to one feature expression;
for any one expression enforcer, comparing the one or more transaction feature values with a target value corresponding to each expression enforcer to obtain a comparison result of the expression enforcer; and
determining a matching result of the rule enforcer according to the comparison results of all expression enforcers.

19. The computer-readable storage medium according to claim 17, wherein before determining the one or more transaction key values and the one or more transaction feature values of the to-be-processed transaction according to the transaction information of the to-be-processed transaction, the method further comprises:
obtaining a to-be-parsed rule union, the to-be-parsed rule union including a plurality of to-be-parsed rules;
for any one to-be-parsed rule, determining the rule enforcer corresponding to the to-be-parsed rule according to a logical relationship and a feature expression in the to-be-parsed rule; and
according to the rule enforcers corresponding to the plurality of to-be-parsed rules, generating a pool of the rule enforcers corresponding to the to-be-parsed rule union.

20. The computer-readable storage medium according to claim 19, wherein before obtaining the to-be-parsed rule union, the method further comprises:
determining one or more feature variables based on the message information;
using the one or more feature variables to generate one or more feature expressions;
connecting the one or more feature expressions through logical symbols to generate the plurality of to-be-parsed rules; and
combining the plurality of to-be-parsed rules of a same service type into the to-be-parsed rule union.
